(19) United States
(12) Patent Application Publication
(10) Pub. No.: US 2014/0351005 A1
(43) Pub. Date: Nov. 27, 2014

(54) Data Collection Method and Apparatus

(71) Applicant: HITACHI, LTD., Tokyo (JP)

(72) Inventors: Nobuaki KOHINATA, Los Gatos, CA (US); Yoshimasa MASUOKA, San Jose, CA (US)

(21) Appl. No.: 13/902,460

(22) Filed: May 24, 2013

(51) Int. Cl. G06Q 50/00; G06Q 30/02

(52) U.S. Cl. CPC G06Q 50/01; G06Q 30/0201
USPC 705/7.29

(57) ABSTRACT

Example implementations described herein are directed to collection of social media information based on a social media event. The example implementations provide for the service of digital marketing, especially for public sector marketing in which it may be necessary to collect user's needs and opinions at the early stage. The example implementations may determine a start time for collection of social media based on the social media event, as well as a stop time.

### BACKGROUND

1. Field

The present application is generally directed to data collection, and more specifically, to data collection of social media.

2. Related Art

Social media has become a mainstream communication channel, and has changed communication methods not only between individuals but also between organizations and their current and/or future targets. For example, companies have started utilizing social media for product advertisement and marketing; as a customer contact center; and for measuring the reputation of their own products and services offered. The use of social media for marketing, (e.g. digital marketing), collecting customers' opinions about the company's products and the company's competitor's products via social media, and analyzing the opinions of the collected data, has become popular in the private sector.

As for the public sector, some governments have become interested in social media for communication with a large number of citizens. For example, the government can be aware of a risky pothole on the sidewalk in a downtown area through a citizen's notification, or let citizens be informed of the development process of new policies that will be issued in the future via social media. Citizens can also find public information announced by a government with ease and no delay. As shown in the current examples above, social media and its usage are widely expanding to both the private and public sectors, and have potential for a method to collect the so-called “Voice of the Citizens” (e.g. social media information, such as blog posts, website comments, status updates, etc. of citizens) without interactions that traditional survey systems impose on the party.

However, when an interesting topic, such as improving aged public infrastructure in a home town, is found in a micro blog or other kinds of social media, there is a problem that the source of data may become overly large, and may include a varied spectrum of topics and noise. Thus, it may become difficult to collect the right voice at the right time before analyzing the rare voices, to find the opinions and needs in detail.

There is a need to address the above described problem and to influence the efficiency of collecting the social media information that include citizen's opinions and needs related to specific topics, especially for public infrastructure.

### SUMMARY

Aspects of the present application include a data collecting method, computer readable medium, and apparatus that determines a start and stop time for collecting social media information when the social media information includes needs and opinions (e.g. blog posts, status updates for social media websites, website comments, etc.) related to the public infrastructure, based on the status of incidents occurred. The aspects may involve monitoring registered news sites periodically and capturing the article if it will have an effect on public infrastructure; determining social event status by looking for key terms in the contents of a captured article and checking if the is still article online; determining the start and stop times for the collection of the social media information; perform the collection of the social media information with generated search words that are related to specific public infrastructure at the start time, also terminate collection at the stop time; and display the result of the collected social media information.

### BRIEF DESCRIPTION OF THE DRAWINGS

FIG. 1 illustrates a model of a typical pattern of the number of the social media information measured against social events.

FIG. 2 illustrates an example of the data collection apparatus upon which example implementations may be implemented.

FIG. 3 illustrates an example hardware diagram of the data collection apparatus, upon which example implementations may be implemented.

FIG. 4 illustrates an example of a flow diagram of a first example implementation of a data collection method.

FIG. 5 illustrates an example of a detailed flow diagram of the monitor and capture social event feature of the first example implementation of a data collection method.

FIG. 6 illustrates an example of a detailed flow diagram of the determine social event status feature of the first example implementation of the data collection method.

FIG. 7 illustrates an example of a detailed flow diagram of adding the event into the social event table for a first example implementation of the determine social event status feature.

FIG. 8 illustrates an example of a detailed flow diagram for determining the collection start and stop time of the social media information for the first example implementation of a data collection method.

FIG. 9 illustrates an example of a detailed flow diagram of search term generation feature for determining the collection start and stop time of the social media information for a first example implementation.

FIG. 10 illustrates an example of a detailed flow diagram of the social media information collection feature for a first example implementation of the data collection method.

FIG. 11 illustrates an example of a detailed screen shot diagram of the collected social media information of the first example implementation of the data collection method.

FIG. 12 illustrates an example of a detailed social infrastructure table of the first example implementation of the data collection method.

FIG. 13 illustrates an example of a detailed Social Event Table of the first example implementation of the data collection method.

FIG. 14 illustrates an example of a detailed Restoration Words Table of the first example implementation for the data collection method.

FIG. 15 illustrates an example of an Event State Machine of the first example implementation of the data collection method.

FIG. 16 illustrates an example of a flow diagram of the present invention for the data collection method.

FIG. 17 illustrates an example of a detailed flow diagram of the determining the social event status feature of the second example implementation of the data collection method.

FIG. 18 illustrates an example of a detailed flow diagram of registering the date of occurrence on a social event table for the determining social event status feature, in accordance with the second example implementation.

FIG. 19 illustrates an example of a detailed flow diagram of the Register the Date of Restoration On A Social Event Table feature for the determine social event status feature, in accordance with a second example implementation.

FIG. 20 illustrates an example of a detailed Social Event Table of the second example implementation of the data collection method.

FIG. 21 illustrates an example of a detailed flow diagram of Activate Social Media Information Collection feature of the second example implementation of the data collection method.

FIG. 22 illustrates an example of a detailed flow diagram for determining the Date When Search Starts of the second example implementation for the Activate Social Media Information Collection feature.

FIG. 23 illustrates an example of a flow diagram of a third example implementation for the Data Collection Method.

FIG. 24 illustrates an example of a detailed flow diagram of the Determine Collection Start and Stop Times of Social Media Information feature of the third example implementation for the data collection method.

FIG. 25 illustrates an example of a detailed flow diagram of Activate Social Media Information Collection feature of the third example implementation for the data collection method.

FIG. 26 illustrates an example of a detailed flow diagram of Determine Coefficient k step of the third example implementation for the Activate Social Media Information Collection feature.

### DETAILED DESCRIPTION

Some example implementations are described with reference to drawings. The example implementations that are described herein do not restrict the inventive concept, and one or more elements that are described in the example implementations may not be essential for implementing the inventive concept. Further, although certain elements may be referred to in the singular form, the elements are not intended to be limited to the singular and may also be implemented with one or more of the same element, depending on the desired implementation.

In the following descriptions, the process is described while a program is handled as a subject in some cases. For a program executed by a processor, the program executes the predetermined processing operations. Consequently, the program being processed can also be a processor. The processing that is disclosed while a program is handled as a subject can also be a process that is executed by a processor that executes the program or an apparatus that is provided with the processor (for example, a control device, a controller, and a storage device). Moreover, a part or a whole of a process that is executed when the processor executes a program can also be executed by a hardware circuit as substitute for or in addition to a processor.

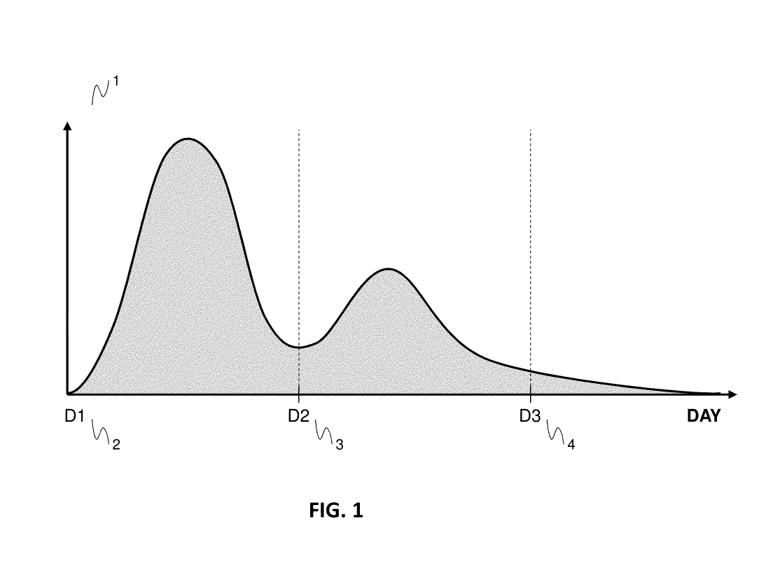

FIG. 1 illustrates an example pattern of a volume of the social media information measured against social events that happened at time D1 (2), which may have an effect on public infrastructure. Observation of the findings of citizen's opinions and needs from social media information in terms of public infrastructure (e.g., drainage and flood control systems in an urban area, video surveillance systems in public facilities, stabilized power distribution system) showed that such postings of social media information appeared during a period of time, from D2 (3) to D3 (4). The example implementations herein disclose how to determine D2 (3), which is the start time to collect social media information with information to infer the status of the social event (e.g., generated search words) and D3 (4), which is the end time to collect social media information.

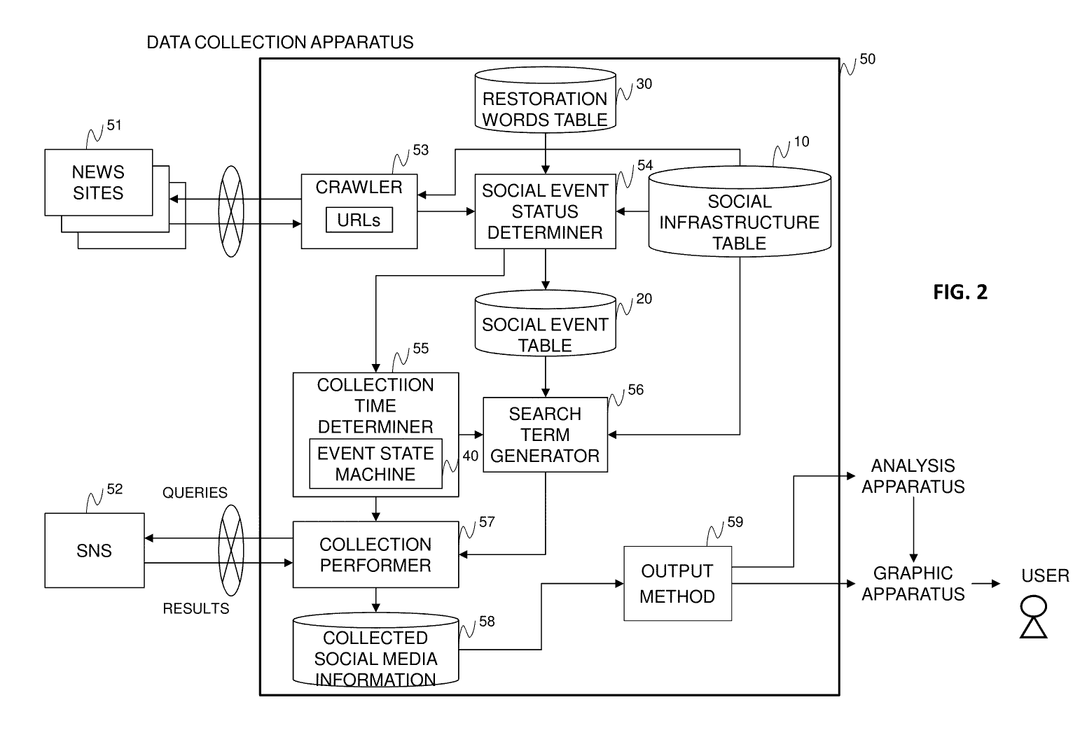

FIG. 2 illustrates an example of the data collection apparatus upon which example implementations may be employed.

The News Sites 51 can be used as the source of social events that are collected by data collection apparatus 50. The Social Networking Services (SNS) 52 can provide the source of the social media information that is collected by the Data Collection Apparatus 50.

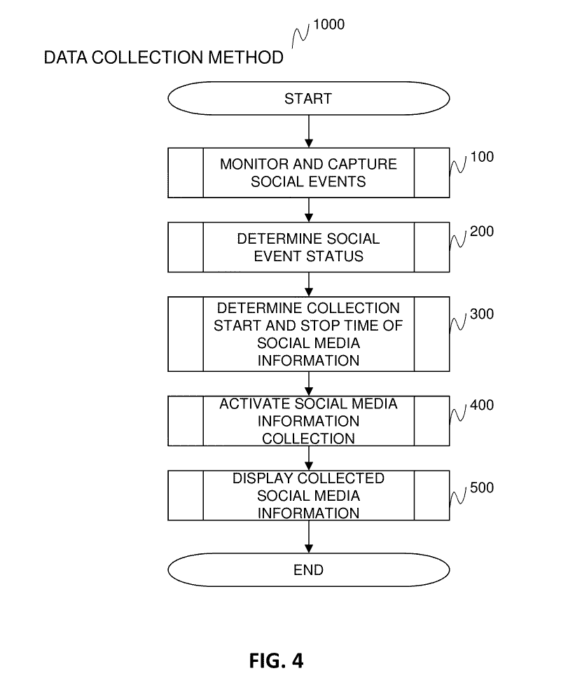

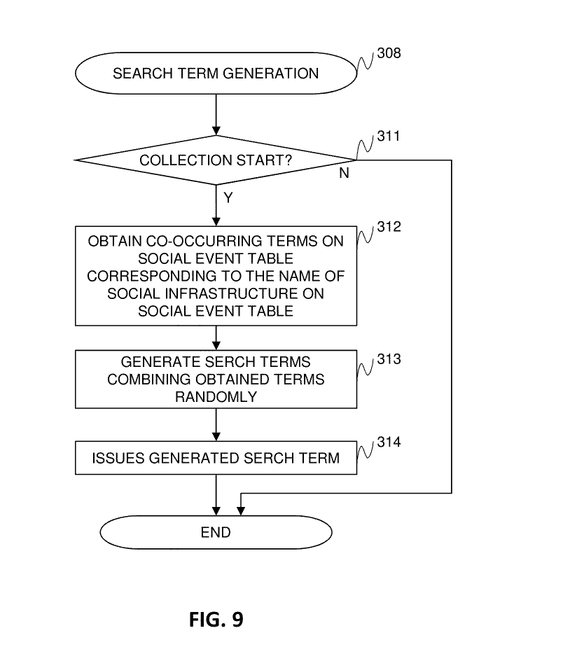

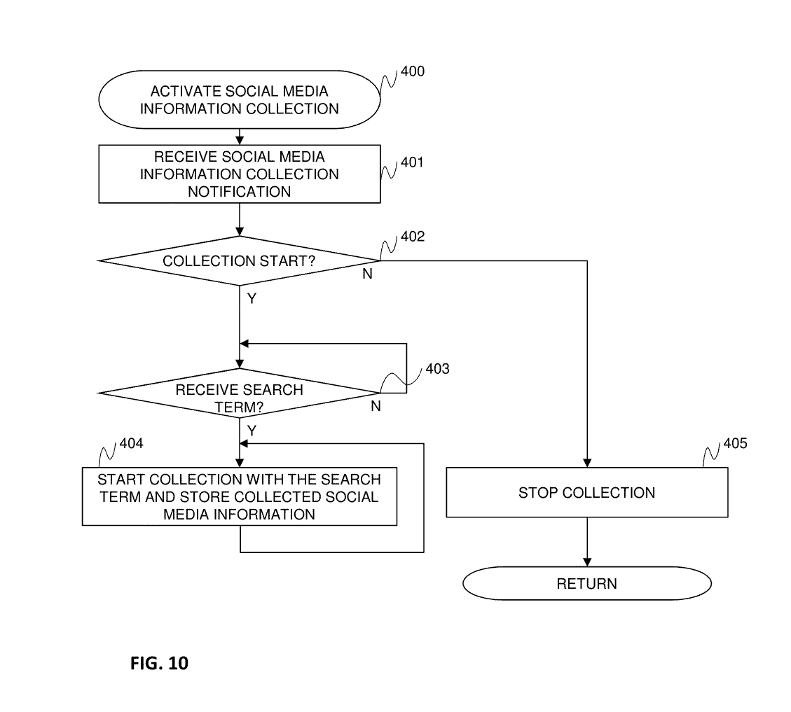

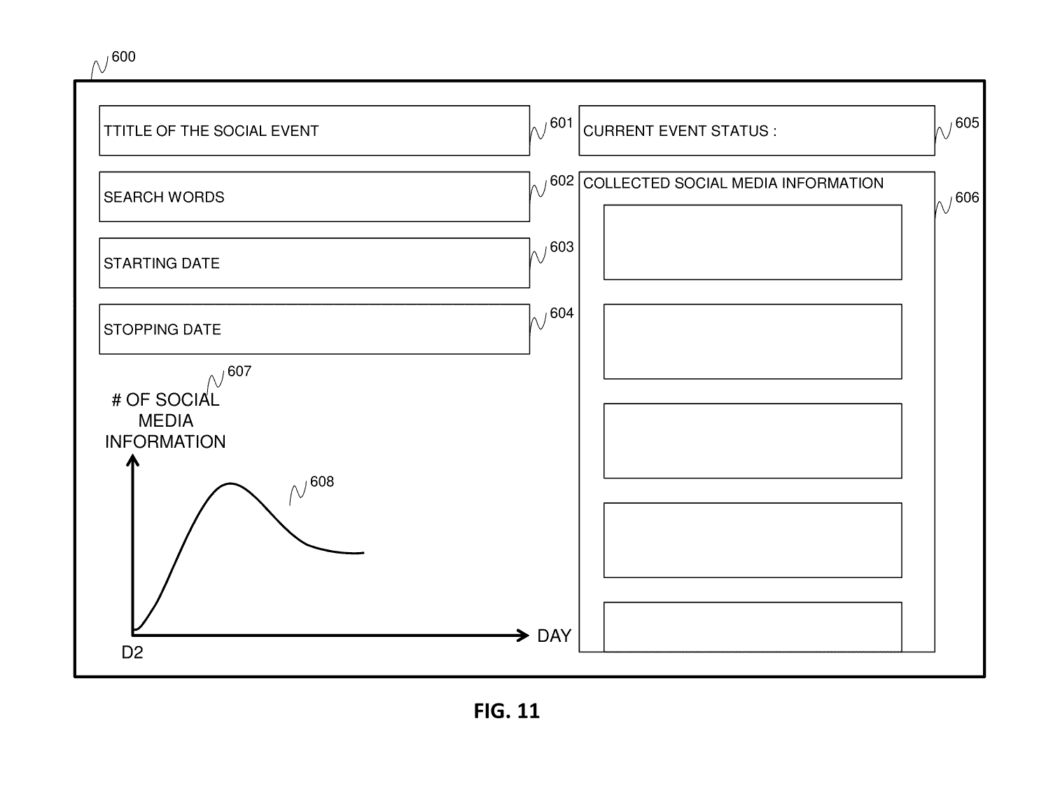

The Crawler 53 provides the function of monitoring and capturing social events as described, for example, in FIG. 4. The Social Event Status Determiner 54 is configured to determine the social event status as described, for example, in FIG. 4. The Collection Time Determiner 55 is configured to determine collection start and stop time of the social media information as described, for example, in FIG. 4. The Search Term Generator 56 is configured to provide search term generation as shown, for example, in FIG. 9. The Collection Performer 57 is configured to collect the social media information, as described, for example, in FIG. 10. The Output Method 59 is configured to display the collected social media information 58, and Output Method 59 may connect with an analysis apparatus for further processing and a graphics apparatus for showing the results and related information via a screen that is shown to users, as illustrated in FIG. 11.

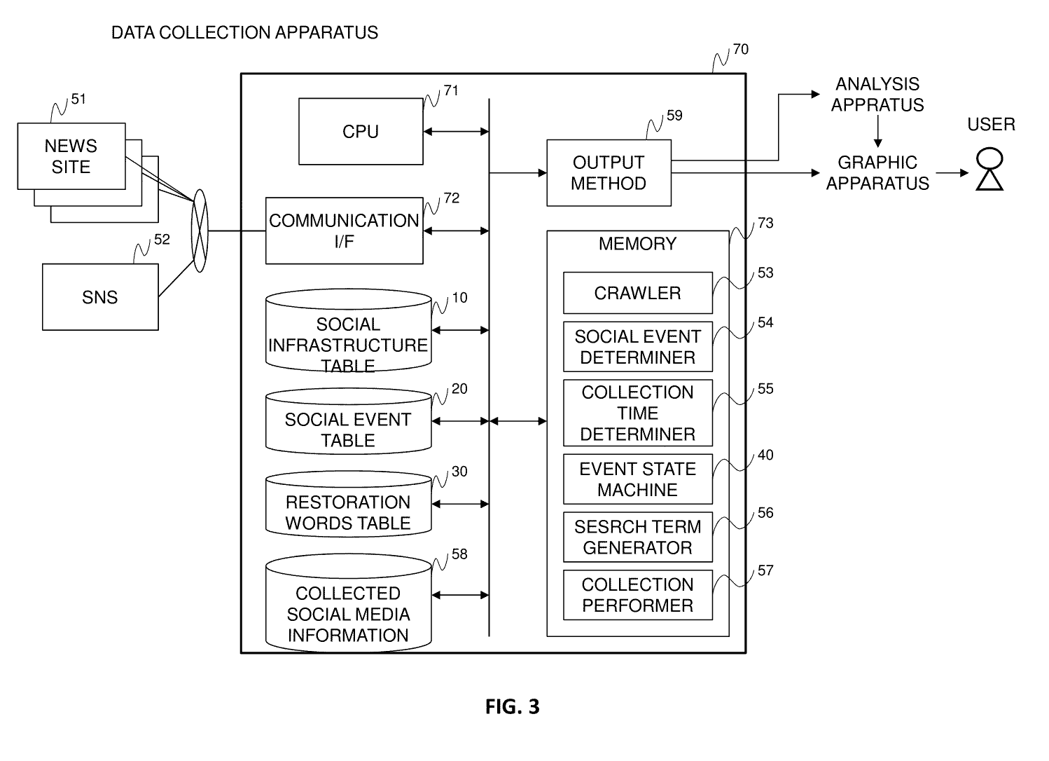

FIG. 3 illustrates an example hardware diagram of the data collection apparatus, upon which example implementations may be implemented. Data Collection Apparatus 70 forms Crawler 53, Social Event Status Determiner 54, Collection Time Determiner 55, Event State Machine 40, Search Term Generator 56, and Collection Performer 57 as software programs that are placed in memory 73, and each program is processed by a central processing unit (CPU) 71. Also, Communication interface (I/F) 72 provides the function that connects to News Sites 51 and SNS 52. Memory 73 may be in the form of a computer readable storage medium, which includes tangible media such as flash memory, random access memory (RAM), HDD, volatile and non-volatile memory, and so on. Alternatively, instructions may be stored in the form of a computer readable signal medium instead of a memory 73, which includes media such as carrier waves.

### First Example Implementation

FIG. 4 illustrates an example of a flow diagram of a first example implementation of a data collection method 1000. The data collection method has the following example features: 1) monitoring and capturing social events (100), 2) determining the social event status (200), 3) determining collection start and stop time of social media information (300), 4) Activate Social Media information collection (400), and 5) display the collected social media information (500). Further details of each of the features are provided below.

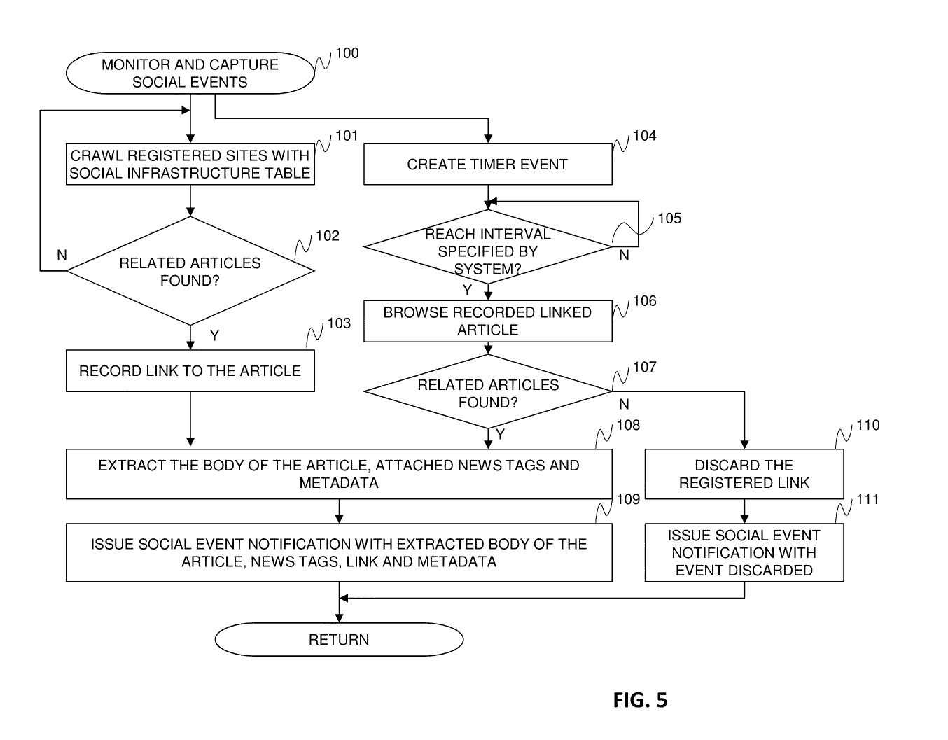

FIG. 5 illustrates an example of a detailed flow diagram of the monitor and capture social event feature 100 of the first example implementation for the data collection method 1000. At 101, a crawl can be performed to crawl registered sites with the social infrastructure table. At 102, if there are articles discovered from the crawl that are related to the social infrastructure described in the registered sites (e.g., articles about repair of infrastructure, commentary, etc. in relation to the registered sites), then the flow proceeds to 103, where the link to the article is recorded (e.g., as a Uniform Resource Locator (URL)) that can link to the article on the web uniquely. At the decision process 102, if the URL to the article is still online, then the process goes to record links to the article as shown at 103. If the URL to the article is not online, and the process gets an error (e.g. site no longer exists) from the new site, then the flow proceeds to 101. The body of the article, attached news tags, and metadata are extracted from the article at 108, and a social event notification is issued with the extracted information at 109.

Upon creation of a timer event (e.g., in parallel or at any time), the recorded links can be periodically browsed as shown at 106 based on a creation of a timer event and processing thereof as shown at 104 and 106, respectively. When the timer event interval is reached at 105 (Y), then the recorded linked article is browsed at 106 for related articles. At the decision process 107, if the URL to the article is still online, then the process goes to 108, to extract the body of the article, attached news tags and metadata. If the URL to the article is not online, and the process gets an error (e.g. site no longer exists) from the new site, then the flow proceeds to 110 to discard the registered link and then to 111 to issue a social event notification to indicate that the event is discarded. At 108, the metadata is an updated date and time for the article.

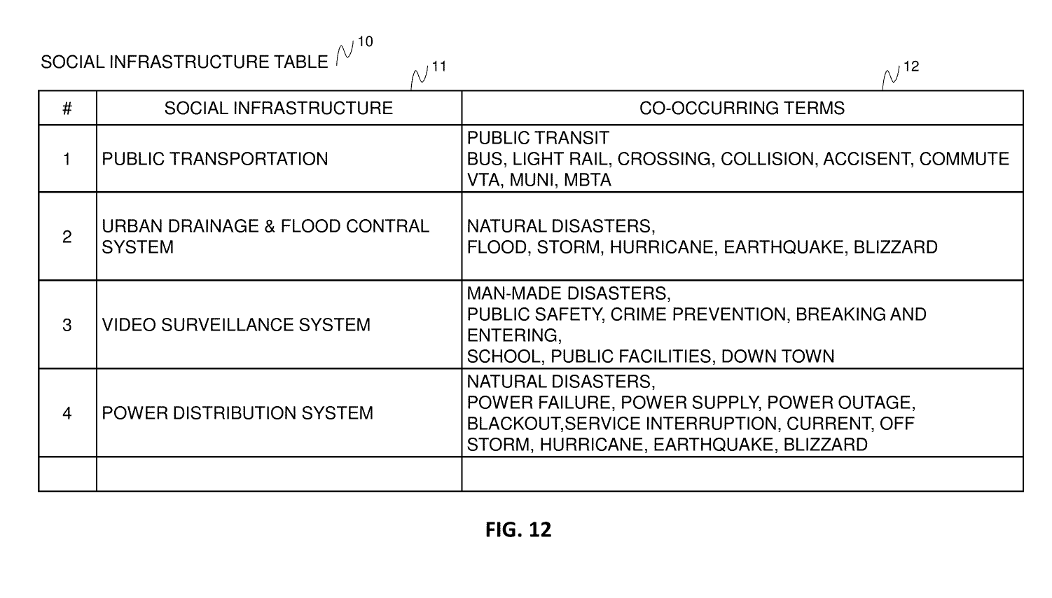

An example of social infrastructure table at the monitor and capture social event feature 100 is shown in FIG. 12. At the monitor and capture social event feature 100, a social event notification can be issued at 109 to proceed to the feature 200. The notification includes the extracted body of the article, news tags, the URL as link information, and the metadata.

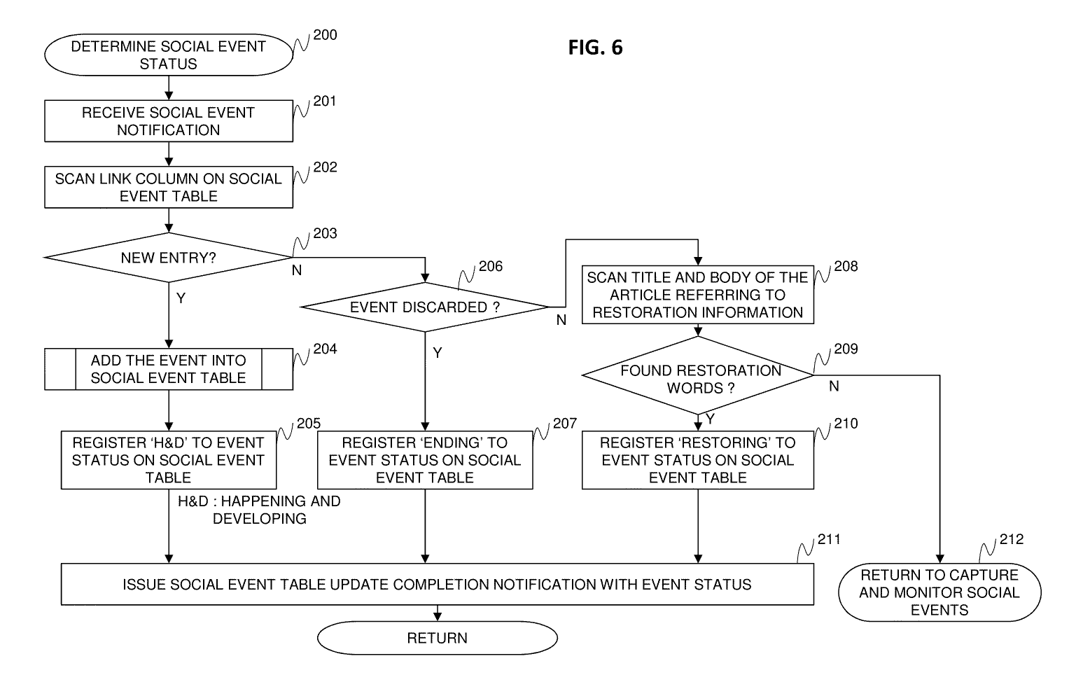

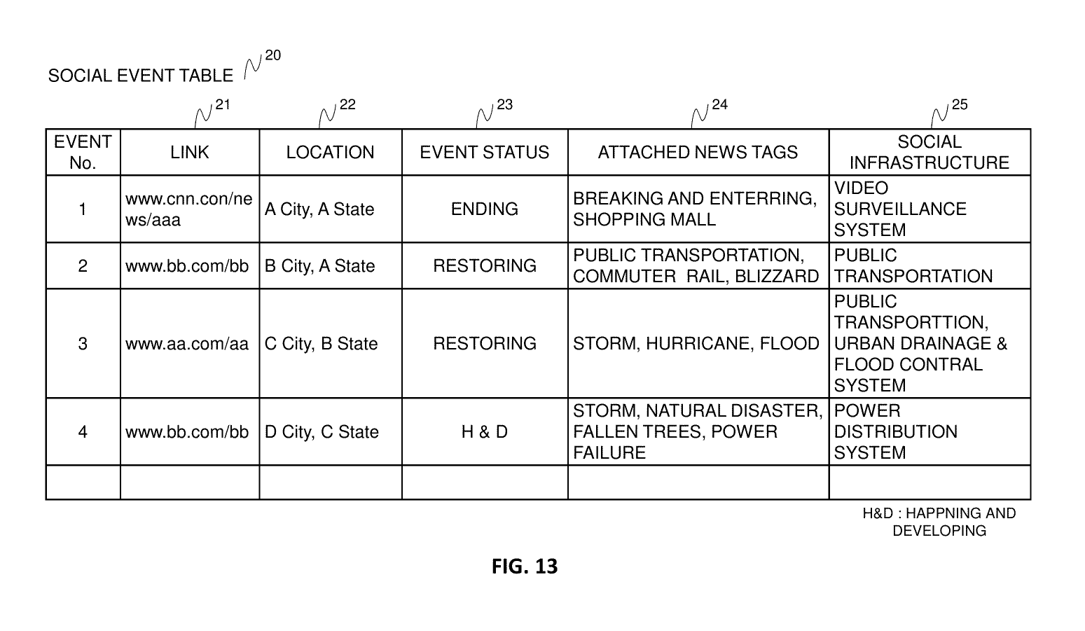

FIG. 6 illustrates an example of a detailed flow diagram of the determine social event status feature 200 of the first example implementation for the data collection method 1000. An example of a social event table is shown in FIG. 13. At 201, a social event notification is received that details a social event, which is compared to a link/URL column on a social event table, as shown at 202. At 203, if the social event notification requires a new entry in the social event table (Y) (e.g., social event does not exist in the table already), then the flow proceeds to 204 to add the event into the social event table, and to indicate the status of the social event as a “happening and developing” status at 205, to indicate that the social event is developing, and to issue a social event table update completion notification with the updated event status at 211.

If the social event notification is in the social event table (N), then the notification is analyzed (e.g., time elapsed, number of social media collected has fallen below a threshold) to determine if the event is to be discarded 206. If the event is to be discarded (Y), then the entry in the social event table is changed to the ending status as shown at 207, and a social event table update completion notification with the updated event status is issued at 211. If the event is not to be discarded (N), then the flow proceeds to 208 to scan the title and the body of the article by referring to information for inferring a restoring status. In the first example implementation, keywords that are used to infer the restoring status are used. At 209, if such restoration words are found in the article (Y) then the social event status is set to the restoring status as shown at 210, and a social event table update completion notification with the updated event status is issued at 211. If the restoration words are not found (N), then the flow proceeds to 212 to capture and monitor social events.

For feature 200, the flow at 211 issues the social event update completion notification to feature 300. The notification includes the same event status that is registered to one of the social event tables at 205, 207, and 210.

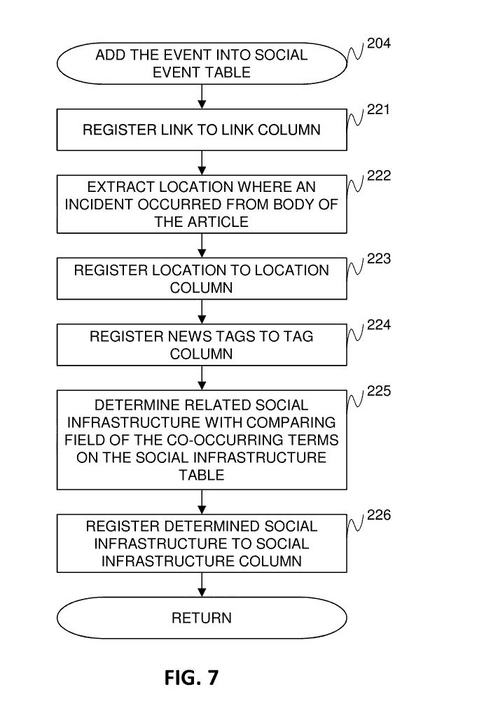

FIG. 7 illustrates an example of a detailed flow diagram of adding the event into the social event table as shown at 204, for a first example implementation of the determine social event status feature 200. An example of a social event table at 204 is shown in FIG. 13.

At 221, the link is registered to the link column of the social event table. At 222, the location where an incident occurred is extracted from the body of the article. At 223, the location of the social event is registered in the location column. At 224, the news tags are registered in the tag column. At 225, a determination is made to determine related social infrastructure, by comparing the field of the co-occurring terms on the social infrastructure table. At 226, the determined social infrastructure is then registered to the social infrastructure column.

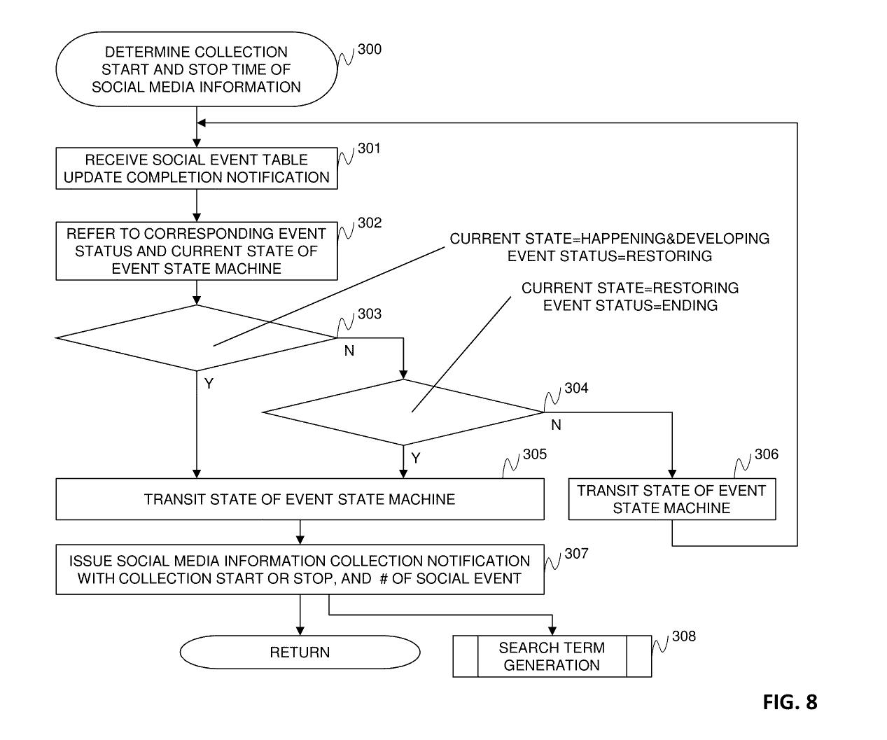

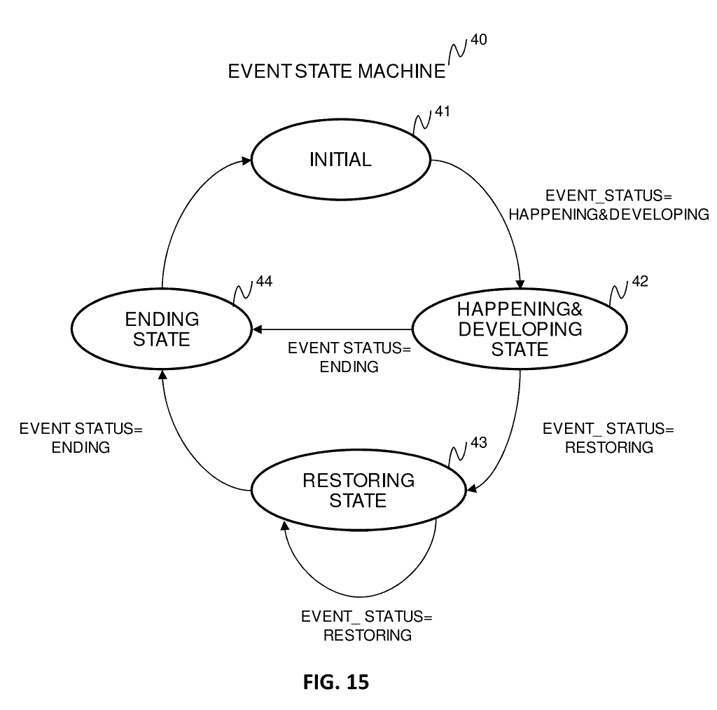

FIG. 8 illustrates an example of a detailed flow diagram for determining the collection start and stop time of the social media information 300 for the first example implementation of the data collection method 1000. An example of an event state machine for feature 300 is shown in FIG. 15.

At 301, the social event table update completion notification is received, wherein the corresponding event status is checked with the event state machine at 302. At 303, if the current state is the “happening and developing” status, and the event status is the restoring status (Y), then the flow proceeds to 305 to transition the state from the “happening and developing” status to the restoring status. Otherwise (N), the flow proceeds to 304 to determine if the current state is the restoring status and the event status is the ending status. If so (Y), then the flow proceeds to 305 to transition the current state from the restoring status to the ending status. Otherwise (N) the flow proceeds to 306 to handle the event state.

At the flow of 307, the social media information collection notification is issued, which is triggered by the transition of the event state machine to the following flow of 308 (search term generation) and feature 400. The notification includes a collection start time and a collection stop time that are used by at 308 and 400, and the social event ID that can be identified by the search term generation at 308. The social event ID may come from the event number column on the social event table.

FIG. 9 illustrates an example of a detailed flow diagram of search term generation feature 308 for determining the collection start and stop time of the social media information 300 for a first example implementation. An example of the social event table is shown in FIG. 13. At 311, a determination is made if a collection should be started. If the collection should be started (Y), then the flow proceeds to 312 to obtain co-occurring terms on the social event table corresponding to the name of the social infrastructure on the social event table. At 313, search terms are generated by combining the obtained co-occurring terms randomly. At 314, the generated search term is issued to feature 400.

FIG. 10 illustrates an example of a detailed flow diagram of the social media information collection feature 400 for a first example implementation of the data collection method 1000. At 401, a notification is received regarding collection of social media information. At 402, if the received Social Media Information collection notification includes a collection start time, then the process goes to 403 to receive search terms and then to 404 to start the collection of the social media information based on the search terms (e.g. search social media sites using search terms, search article sites and comments with search terms), and store the social media information. If the notification does not include a collection start time at 402, (e.g. a collection stop time), then the process goes to 405 to stop the collection of social media information.

FIG. 11 illustrates an example user interface of the collected Social Media Information 500 of the first example implementation of the data collection method 1000. Title of the social event 601 comes from the title of the article; search words 602 shows the generated search word, and search and collection run with this term. Starting date 603 and stopping date 604 correspond to D2 and D3 respectively as shown in FIG. 1. Number of Social Media Information 607 shows the collected number of social media information (e.g., comments, blog posts, status updates, etc.) searched by the search words. Current Event Status 605 shows the current status of the social event that appears on the social event table as shown in FIG. 13. Collected Social Media Information 606 shows the latest social media information collected. Curve graph 608 shows the transition of the collected number of the social media information after the starting date.

FIG. 12 illustrates an example of a detailed social infrastructure table 10 of the first example implementation of the data collection method 1000. Social Infrastructure column 11, stores the title of the social infrastructure(s) of interest, and Co-occurring Terms column 12 stores the related words of each social infrastructure. The related words can be created and added later by using known tools, such as WordNet, but not limited thereto.

FIG. 13 illustrates an example of a detailed Social Event Table 20 of the first example implementation of the data collection method 1000. Social Event Table 20 may contain entries for link 21, location 22, event status 23, attached news tags 24 and social infrastructure 25. The link 21 indicates the link or URL to the article or site of interest. The location 22 indicates the location (e.g., geographical) of the social media event of interest for the corresponding link. The event status 23 indicates the status of the social event (e.g., “happening and developing”, ending, restoration, etc.). The attached news tags 24 indicate news tags that are related to the corresponding link. The social infrastructure 25 indicates the infrastructure in question for the corresponding link.

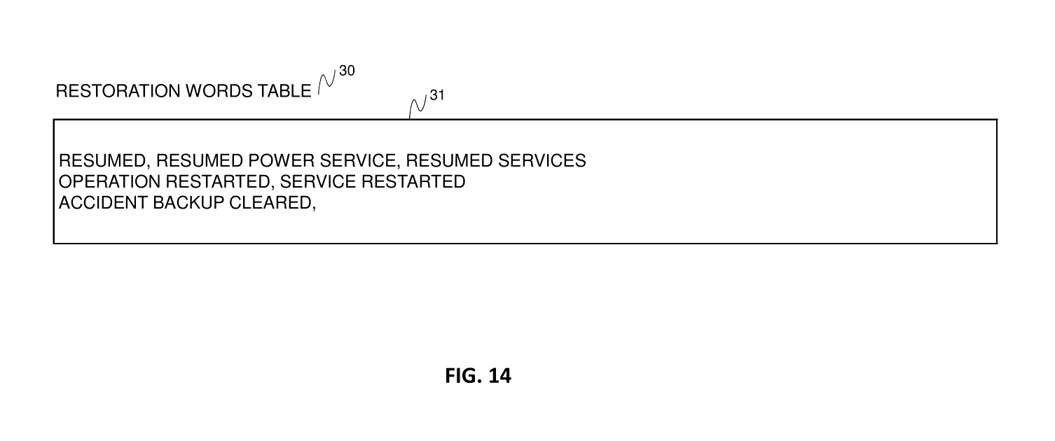

FIG. 14 illustrates an example of a detailed Restoration Words Table 30 of the first example implementation for the data collection method 1000. Restoration Words Table 30 stores information associated with indicating a restoring status of the social event. In this example, the information is in the form of one or more keywords, as shown at 31.

FIG. 15 illustrates an example of an Event State Machine 40 of the first example implementation of the data collection method 1000. The event state machine 40 has four states: Initial state 41, Happening and Developing state 42, Restoration state 43, and Ending state 44. State transition occurs by the reception of the social event table update completion notification, which includes event status and by finishing the decision processing at the flow at 303 and 304 as shown in FIG. 8.

For example, when the current state is Initial 41, if the social event table update completion notification has “happening and developing” as the event status, then the next state is Happening and Developing state 42. And when the current state is Restoring state 43, if the social event table update completion notification has Restoring as event status, then the next state is still Restoring state 43.

### Second Example Implementation

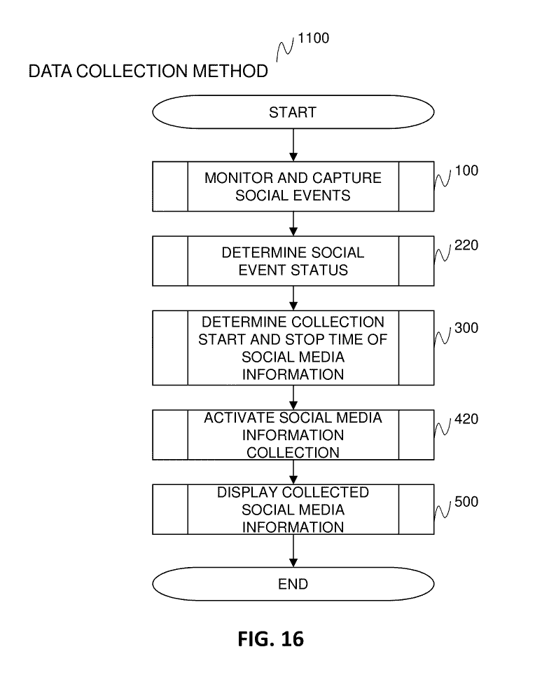

FIG. 16 illustrates an example of a flow diagram of the second example implementation of the Data Collection Method 1100. The Data Collection Method has the following example features: 1) monitor and capture social event feature 100, 2) determine social event status feature 220, 3) determine collection start and stop time of Social Media Information feature 300, 4) activate Social Media Information collection feature 420, and 5) display collected Social Media Information feature 500. Features 100, 300, and 500 are the same as described for the first example implementation, and features 220 and 420 are modified variations. The various features as described above for the first example implementation can also be implemented in the second example implementation as desired.

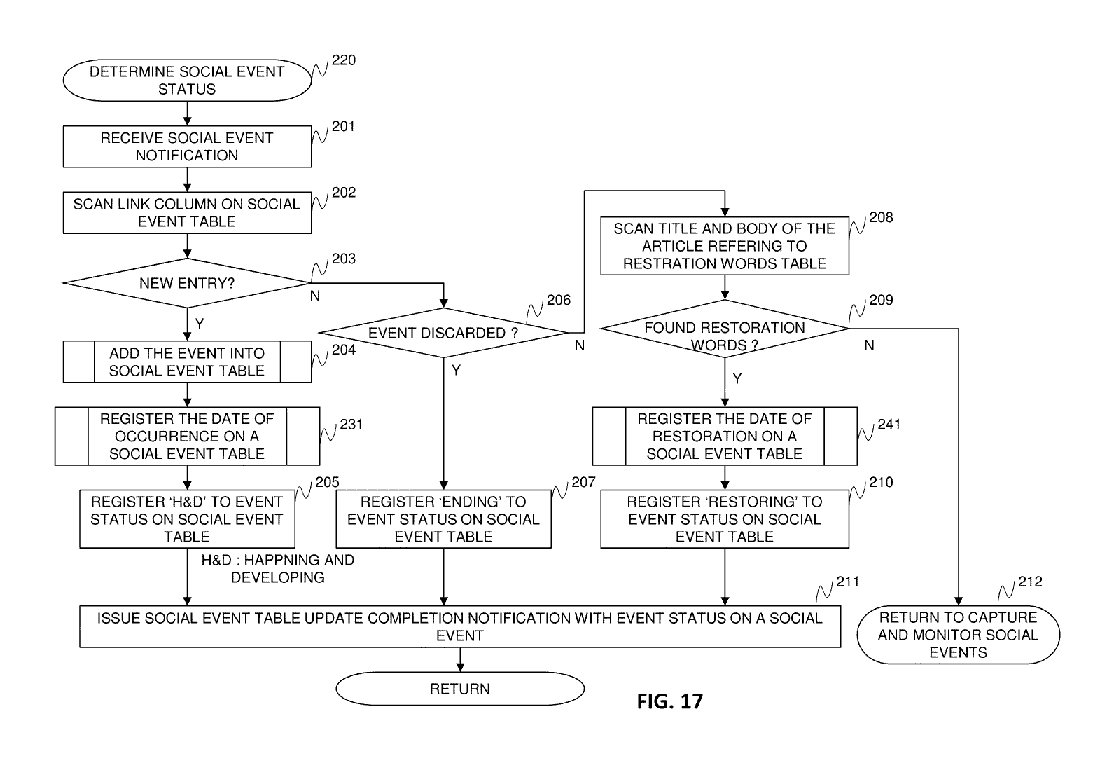

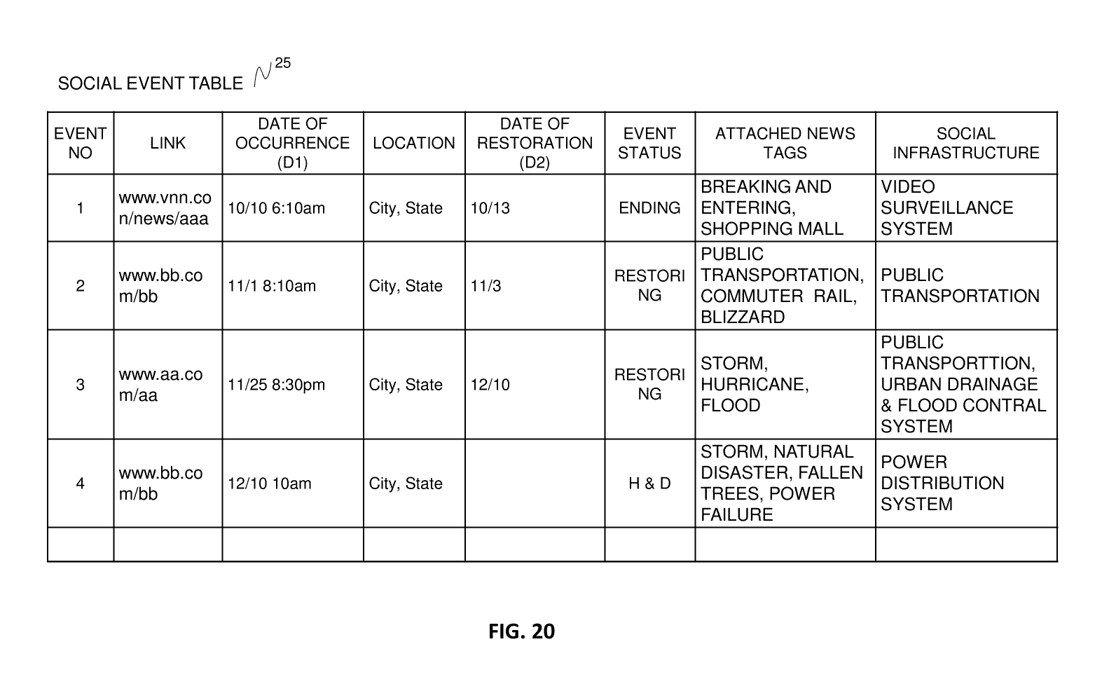

FIG. 17 illustrates an example of a detailed flow diagram of the determining the social event status feature 220 of the second example implementation of the data collection method 1100. The feature 220 is similar to feature 200 as illustrated in FIG. 6. The changes include features Activate Social Media 231 and 241, to register the date of occurrence and date of restoration to the social event table, respectively. An example of social event table at for feature 220 is shown in FIG. 20.

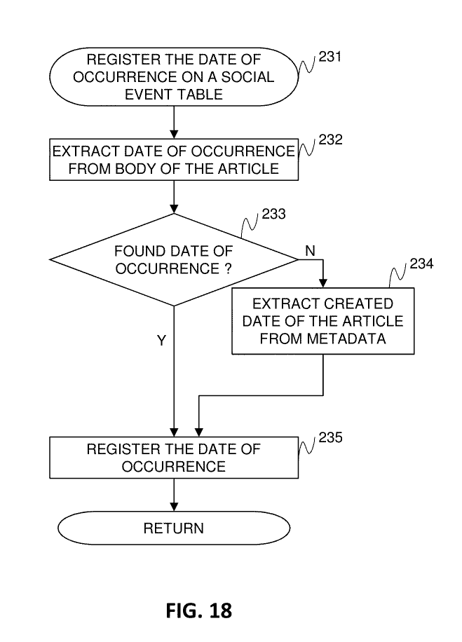

FIG. 18 illustrates an example of a detailed flow diagram of registering the date of occurrence on a social event table 231 for the determine social event status feature 220, in accordance with the second example implementation. At 232, an attempt is made to extract the date of occurrence from the body of the article. At 233, if the date is found (Y), then the flow proceeds to 235 to register the date. Otherwise (N), the date is derived from the metadata of the article 234, and the derived date is registered at 235.

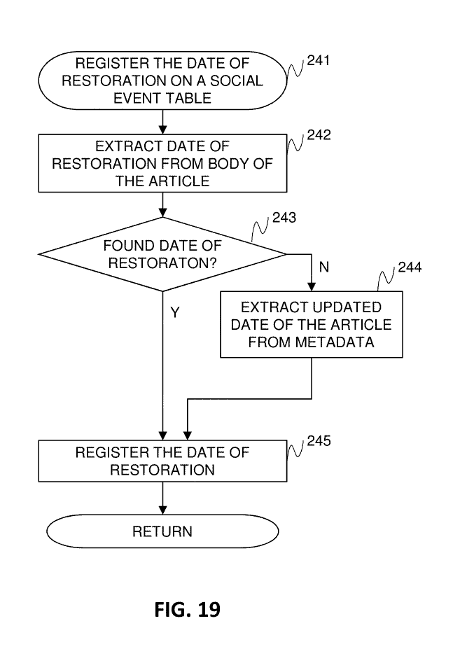

FIG. 19 illustrates an example of a detailed flow diagram of Register the Date of Restoration On A Social Event Table 241 for the determine social event status 220, in accordance with a second example implementation. At 242, an attempt is made to extract the date of restoration from the body of the article. At 243, if the date is found (Y), then the flow proceeds to 245 to register the date. Otherwise (N), the date is derived from the metadata of the article 244, and the derived date is registered at 245.

FIG. 20 illustrates an example of a detailed Social Event Table 25 of the second example implementation of the data collection method 1100. The table is similar to the Social Event Table 20 of the first example implementation, with an additional date of restoration and date of occurrence.

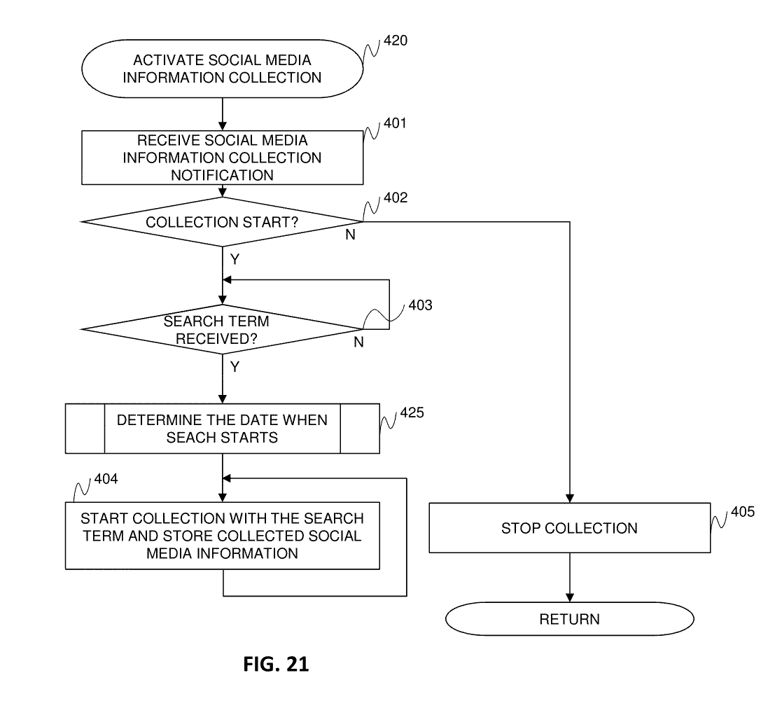

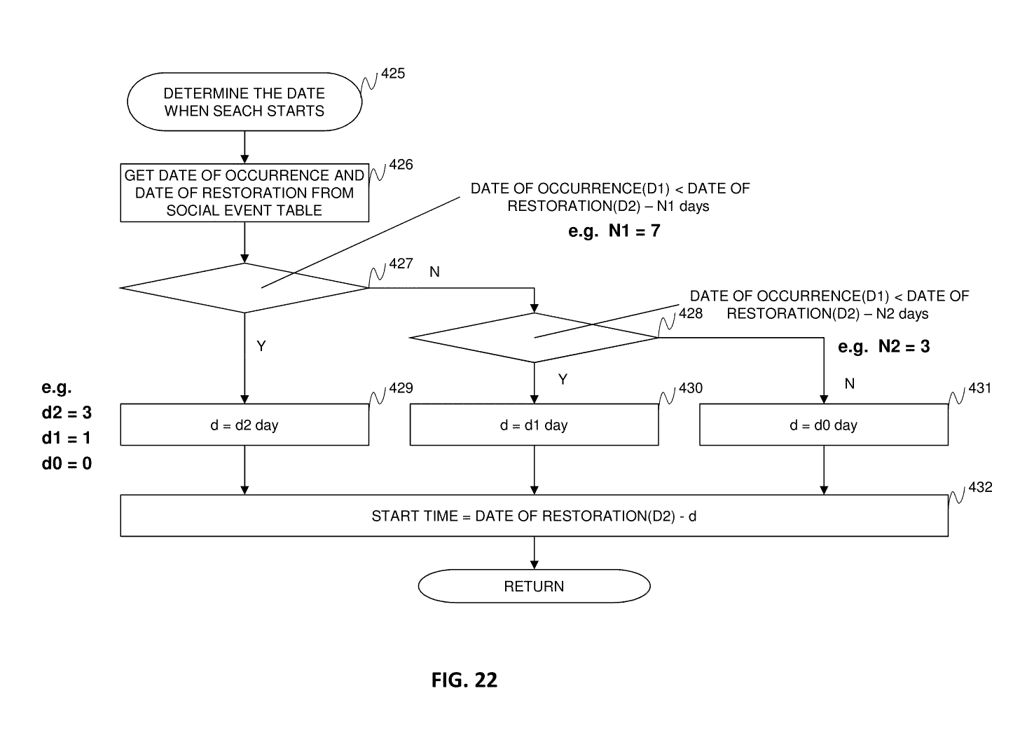

FIG. 21 illustrates an example of a detailed flow diagram of Activate Social Media Information Collection feature 420 of the second example implementation of the data collection method 1100. The feature 420 is similar to the feature 400 as illustrated in FIG. 10, with the additional flow 425 to determine the date when the search starts, as explained in FIG. 22.

FIG. 22 illustrates an example of a detailed flow diagram for determining the Date When Search Starts 425 of the second example implementation for the Activate Social Media Information Collection feature 420. At 426, the date of occurrence and the date of restoration are obtained from the social event table. At 427, a comparison is made from the date of occurrence and the date of restoration to determine an offset d from the date of restoration to start the collection of social media information based on a threshold period of time N.

In the example of FIG. 22, the threshold period of time is set to seven days for N1 and three days for N2. The offsets are set to three days for d2, one day for d1 and zero days for d0. Comparisons are made at 427, 428, and 429 to determine if date of restoration occurs within N1, N2 or N3 of the date of occurrence, respectively. Based on the comparison, an offset d2, d1, d0 is selected at 429, 430 and 431 respectively. The activation of the collection of social media information begins at the date of restoration offset by the selected offset at 432. The threshold time period and the offset can be configured depending on the desired implementation.

### Third Example Implementation

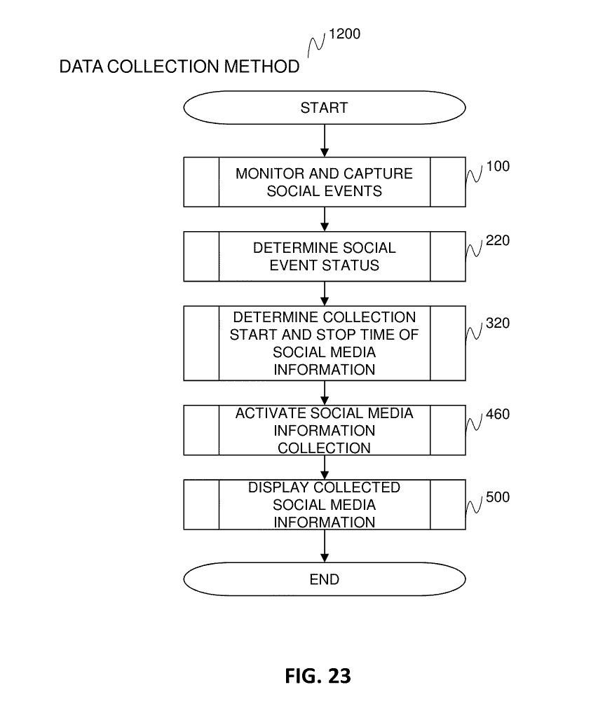

FIG. 23 illustrates an example of a flow diagram of a third example implementation for the Data Collection Method 1200. The data collection method has the following five features: 1) Monitor and Capture Social Event feature 100, 2) Determine Social Event Status feature 220, 3) Determine Collection Start and Stop times of Social Media Information feature 320, 4) Activate Social Media Information Collection feature 460, and 5) Display Collected Social Media Information feature 500. Features 100 and 500 are the same as in the first example implementation. Feature 220 is the same as in the second example implementation. Features 320 and 460 are described in more detail below.

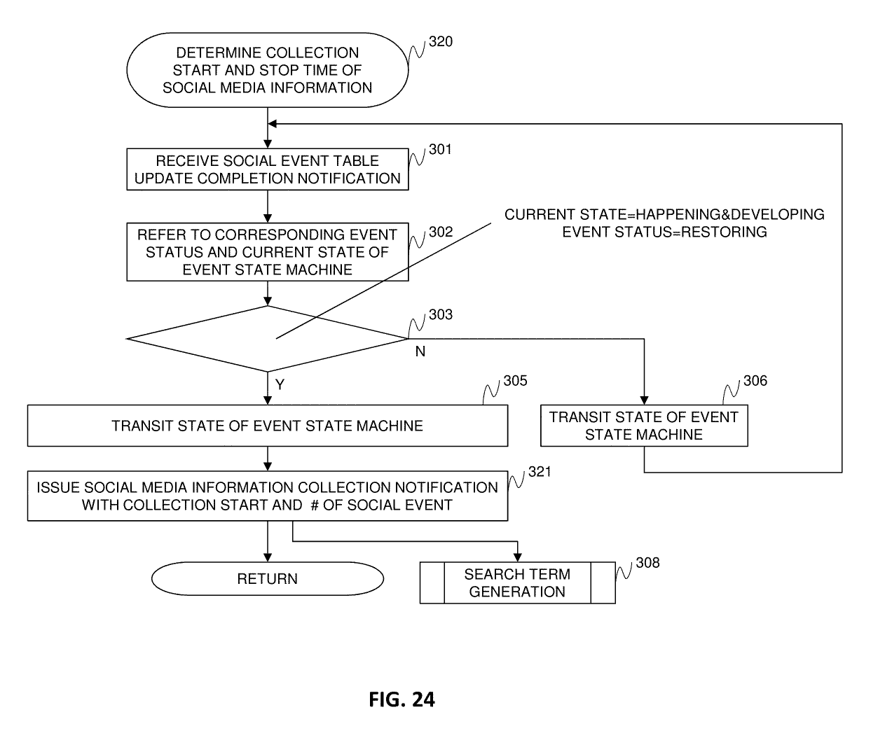

FIG. 24 illustrates an example of a detailed flow diagram of the Determine Collection Start and Stop Times of Social Media Information feature of the third example implementation for the data collection method 1200. As illustrated in FIG. 24, the flow diagram is similar to the feature 300 as illustrated in FIG. 8, with an additional flow at 321 to issue the social media information collection notification triggered by the transition of event state machine to the following feature 308 and 460. The notification includes a collection start that is used by features 308 and 460, and the social event ID that can be identified by the following feature 308. The social event ID may be received from the event number column on the social event table.

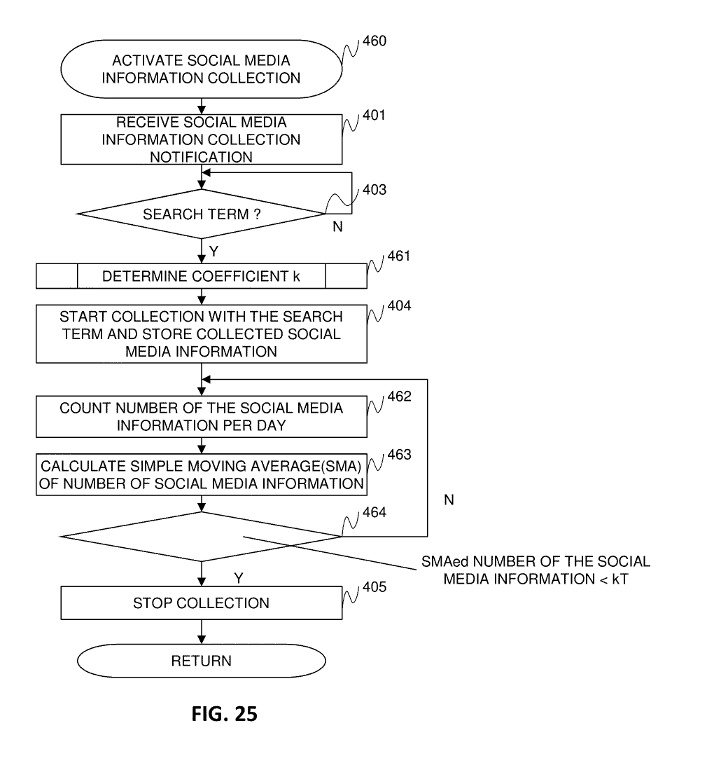

FIG. 25 illustrates an example of a detailed flow diagram of Activate Social Media Information Collection feature 460 of the third example implementation for the data collection method 1200. The flow is similar to the flow as illustrated in FIG. 10 with some differences. For example, the flow at 461 provides for a determination for a coefficient k for a decay threshold or drop off magnitude threshold of the collection of social media information. At the flow at 464, T denotes the maximum simple moving average (SMA) value of social media information after the flow at 404, and can be used with the coefficient k to determine if the collection of social media information should be stopped. The flow at 463 also records the T daily, though this can be changed (e.g. weekly, hourly, etc.), depending on the desired implementation.

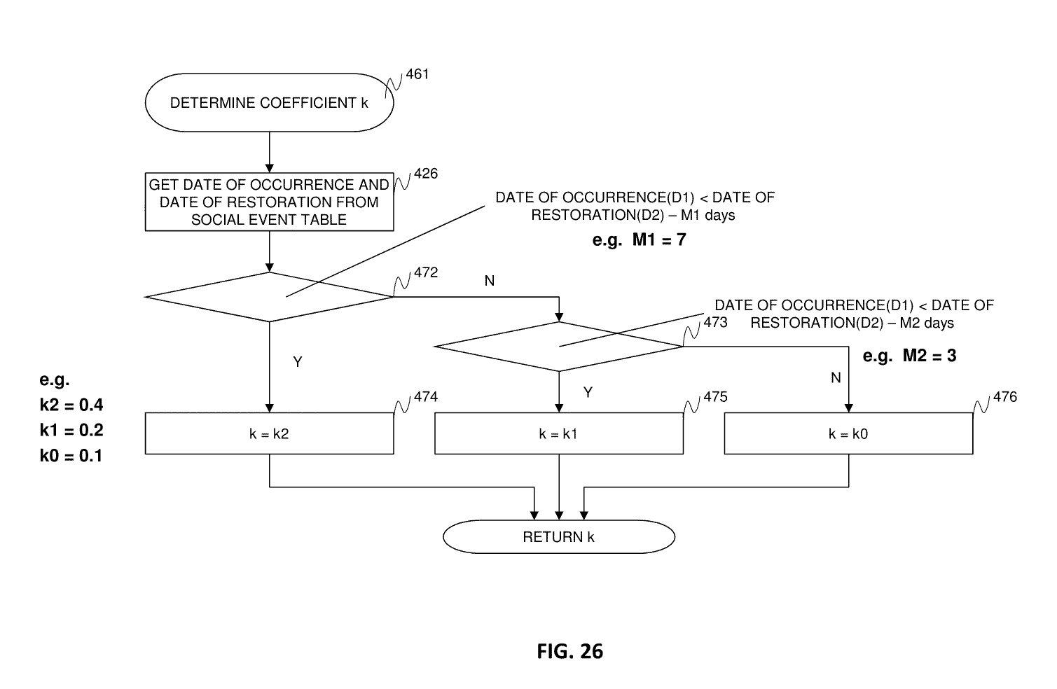

FIG. 26 illustrates an example of a detailed flow diagram of Determine Coefficient k feature 461 of the third example implementation for the Activate Social Media Information Collection feature 460. In the example of FIG. 26, the threshold period of time is set to seven days for M1 and three days for M2. The coefficients are set to 0.4 for k2, 0.2 for k1 and 0.1 for k1. Comparisons are made at 472 and 473 to determine if date of restoration occurs within M1 or M2 of the date of occurrence, respectively. Based on the comparison, a coefficient k2, k1, k0 is selected at 474, 475 and 476 respectively. The threshold time period and the coefficient can be configured depending on the desired implementation.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. An apparatus, comprising:
a memory configured to store information for inferring a restoring status; and
a processor configured to:
determine a start time for collecting social media information associated with a social event, based on a calculation of a transition of the social event to the restoring status, the calculation based on the information for inferring the restoring status stored in the memory; and
activate collection of the social media information related to the social event from the determined start time.

2. The apparatus of claim 1, wherein the processor is configured to deactivate the collection of the social media information based on a drop off magnitude of the social media information collected.

3. The apparatus of claim 2, wherein the processor is further configured to determine the drop off magnitude based on a moving average of social media information collected.

4. The apparatus of claim 1, wherein the processor is configured to determine the start time from an offset from a transition date of the restoring status based on a comparison of a date of occurrence of the social event and the transition date of the restoring status.

5. The apparatus of claim 1, wherein the information for inferring the restoring status comprises one or more search terms, and wherein the processor is configured to infer the restoring status by searching the social media information for the one or more search terms.

6. The apparatus of claim 1, wherein the processor is configured to collect social media information by a search of the social media information from one or more search terms generated by the processor.

7. A computer readable storage medium, storing instructions for executing a process, the instructions comprising:
determining a start time for collecting social media information associated with a social event, based on a calculation of a transition of the social event to the restoring status, the calculation based on information for inferring the restoring status; and
activating collection of the social media information related to the social event from the determined start time.

8. The computer readable storage medium of claim 7, wherein the instructions further comprise deactivating the collection of the social media information based on a drop off magnitude of the social media information collected.

9. The computer readable storage medium of claim 8, wherein the instructions further comprise determining the drop off magnitude based on a moving average of social media information collected.

10. The computer readable storage medium of claim 7, wherein the instructions further comprise determining the start time from an offset from a transition date of the restoring status based on a comparison of a date of occurrence of the social event and the transition date of the restoring status.

11. The computer readable storage medium of claim 7, wherein the information for inferring the restoring status comprises one or more search terms, and wherein the instructions further comprise inferring the restoring status by searching the social media information for the one or more search terms.

12. The computer readable storage medium of claim 7, wherein the collecting social media information comprises:
generating one or more search terms, and
searching the social media information from the one or more search terms.

13. A method, comprising:
determining a start time for collecting social media information associated with a social event, based on a calculation of a transition of the social event to the restoring status, the calculation based on information for inferring the restoring status; and
activating collection of the social media information related to the social event from the determined start time.

14. The method of claim 13, further comprising deactivating the collection of the social media information based on a drop off magnitude of the social media information collected.

15. The method of claim 14, further comprising determining the drop off magnitude based on a moving average of social media information collected.

16. The method of claim 13, further comprising determining the start time from an offset from a transition date of the restoring status based on a comparison of a date of occurrence of the social event and the transition date of the restoring status.

17. The method of claim 13, wherein the information for inferring the restoring status comprises one or more search terms, and further comprising inferring the restoring status by searching the social media information for the one or more search terms.

18. The method of claim 13, wherein the collecting social media information comprises:
generating one or more search terms, and
searching the social media information from the one or more search terms.
